(19) United States
(12) Patent Application Publication
(10) Pub. No.: US 2012/0013835 A1
(43) Pub. Date: Jan. 19, 2012

(54) LIQUID CRYSTAL DISPLAY APPARATUS

(76) Inventor: Masatoshi Itoh, Osaka (JP)

(21) Appl. No.: 13/259,663

(22) PCT Filed: Mar. 15, 2010
(86) PCT No.: PCT/JP2010/001841

§ 371 Date: Sep. 23, 2011

(30) Foreign Application Priority Data
Mar. 25, 2009 (JP) 2009-075110

(51) Int. Cl. G02F 1/1337

(52) U.S. Cl. 349/123

(57) ABSTRACT

A liquid crystal display device according to the present invention (100) includes: a first substrate (140) having a first electrode (144) and a first alignment film (146); a second substrate (120) having a second electrode (124) and a second alignment film (126); a liquid crystal layer (160) interposed between the first and second alignment films (126, 146); and alignment sustaining layers (130, 150) provided on the liquid crystal layer (160) side of the first and second alignment films (126, 146). The first electrode (144) includes a conductive portion (144a) and a non-conductive portion (144b) surrounded by the conductive portion (144a). The first substrate (140) further includes an insulating layer (148) at least partly covered by the first electrode (144). At a position corresponding to the non-conductive portion (144b), the insulating layer (148) includes a region (148H) which is made of a material having a specific resistance of 10¹⁵ Ωcm or more.

### TECHNICAL FIELD

The present invention relates to a liquid crystal display device, and more particularly to a liquid crystal display device having an alignment sustaining layer.

### BACKGROUND ART

Liquid crystal display devices are used not only as large-sized television sets, but also as small-sized display devices, e.g., the display sections of mobile phones. Liquid crystal display devices of the TN (Twisted Nematic) mode, which have often been used conventionally, have relatively narrow viewing angles. In recent years, however, liquid crystal display devices with wide viewing angles have been produced, e.g., the IPS (In-Plane Switching) mode and the VA (Vertical Alignment) mode. Among such modes with wide viewing angles, the VA mode is adopted in a large number of liquid crystal display devices because of an ability to realize a high contrast ratio. A liquid crystal display device includes alignment films defining the alignment directions of the liquid crystal molecules in their neighborhood. In the case of a VA-mode liquid crystal display device, an alignment film aligns liquid crystal molecules so as to be substantially perpendicular to its principal face.

As one kind of VA mode, the MVA (Multi-domain Vertical Alignment) mode is known, under which a plurality of liquid crystal domains are created in one pixel region. An MVA-mode liquid crystal display device includes alignment regulating structures provided on the liquid-crystal-layer side of at least one of a pair of opposing substrates, between which a vertical-alignment type liquid crystal layer is interposed. The alignment regulating structures may be linear slits (apertures) or ribs (protruding structures) that are provided on electrodes, for example. The alignment regulating structures provide alignment regulating forces from one side or both sides of the liquid crystal layer, thus creating a plurality of liquid crystal domains (typically four liquid crystal domains) with different alignment directions, whereby the viewing angle characteristics are improved.

Also known as another kind of VA mode is the CPA (Continuous Pinwheel Alignment) mode. In a generic liquid crystal display device of the CPA mode, pixel electrodes of a highly symmetrical shape are provided, and on a counter electrode, protrusions are provided corresponding to the centers of liquid crystal domains. These protrusions are also referred to as rivets. When a voltage is applied, in accordance with an oblique electric field which is created with the counter electrode and a highly symmetrical pixel electrode, liquid crystal molecules take an inclined alignment of a radial shape. Moreover, the inclined alignment of the liquid crystal molecules are stabilized due to the alignment regulating forces of side slopes of the rivets. Thus, the liquid crystal molecules in one pixel are aligned in a radial shape, thereby improving the viewing angle characteristics.

In the generic VA mode, liquid crystal molecules are aligned in the normal direction of the principal face of an alignment film in the absence of an applied voltage, and when a voltage is applied across the liquid crystal layer, the liquid crystal molecules are aligned in a predetermined direction. On the other hand, in order to improve the response speed of a liquid crystal display device, use of a Polymer Sustained Alignment Technology (hereinafter referred to as the “PSA technique”) is under study (see Patent Documents 1 and 2). In the PSA technique, while applying a voltage across a liquid crystal layer having a small amount of polymerizable compound (e.g., a photopolymerizable monomer) mixed thereto, polymerization of the polymerizable compound is effected, thus controlling the pretilt directions of the liquid crystal molecules. As a result, a pretilt is conferred such that the liquid crystal molecules are inclined from the normal direction of the principal face of the alignment film in the absence of an applied voltage.

The liquid crystal display device of Patent Document 1 is of an MVA mode where slits or ribs are provided as alignment regulating structures. When the liquid crystal display device of Patent Document 1 is viewed from the normal direction of the principal face of a substrate, linear slits and/or ribs are provided so that the liquid crystal molecules will be aligned orthogonal to the slits or ribs under an applied voltage. When ultraviolet light is radiated in this state, a polymer is formed, thus allowing the alignment state of the liquid crystal molecules to be sustained (stored). Thereafter, even if voltage application is stopped, the liquid crystal molecules will still be inclined in a pretilt azimuth from the normal direction of the principal face of the alignment film.

The liquid crystal display device of Patent Document 2 includes an electrode having a minute stripe pattern such that, when a voltage is applied across the liquid crystal layer, the liquid crystal molecules are aligned in parallel to the longitudinal direction of the stripe pattern. This is in contrast to the liquid crystal display device of Patent Document 1, where the azimuth angle component of the liquid crystal molecules is orthogonal to the slits or ribs. Moreover, since a plurality of slits are provided, disorder in the alignment is suppressed. In this state, ultraviolet light is radiated so as to allow the alignment state of the liquid crystal molecules to be sustained (stored). Thereafter, even if voltage application is stopped, the liquid crystal molecules will be inclined in the pretilt azimuth from the normal direction of the principal face of the alignment film. In this manner, a pretilt is conferred to the liquid crystal molecules in the absence of an applied voltage, thus obtaining an improved response speed.

### CITATION LIST

### Patent Literature

[Patent Document 1] Japanese Laid-Open Patent Publication No. 2002-357830
[Patent Document 2] Japanese Laid-Open Patent Publication No. 2003-149647

### SUMMARY OF INVENTION

### Technical Problem

In the liquid crystal display devices of Patent Documents 1 and 2, the liquid crystal molecules may not be aligned in a predetermined direction, thus deteriorating the display quality.

The present invention has been made in view of the above problems, and an objective thereof is to provide a liquid crystal display device in which deteriorations in display quality are reduced.

### Solution to Problem

A liquid crystal display device according to the present invention comprises: a first substrate having a first electrode and a first alignment film; a second substrate having a second electrode and a second alignment film; a liquid crystal layer interposed between the first alignment film and the second alignment film; and an alignment sustaining layer provided on the liquid crystal layer side of each of the first alignment film and the second alignment film, wherein, the first electrode includes a conductive portion and a non-conductive portion whose perimeter is at least partly surrounded by the conductive portion; the first substrate further includes an insulating layer at least partly covered by the first electrode; and at a position corresponding to the non-conductive portion, the insulating layer includes a region which is made of a material having a specific resistance of 10¹⁵ Ωcm or more.

In one embodiment, at a position overlapping the conductive portion, the insulating layer further includes a region which is made of a material having a specific resistance of less than 10¹⁵ Ωcm.

In one embodiment, the insulating layer includes: a first insulating layer including the region which is made of the material having a specific resistance of less than 10¹⁵ Ωcm; and a second insulating layer including the region which is made of the material having a specific resistance of 10¹⁵ Ωcm or more.

In one embodiment, the second insulating layer is provided on the liquid crystal layer side of the first insulating layer.

In one embodiment, the first substrate is a front substrate.

In one embodiment, the insulating layer functions as a color filter layer.

In one embodiment, the first substrate is a rear substrate.

In one embodiment, the conductive portion of the first electrode includes a plurality of unit portions which are electrically connected to one another; and the region of the insulating layer that is made of the material having a specific resistance of 10¹⁵ Ωcm or more is provided corresponding to an interspace between two adjoining unit portions among the plurality of unit portions.

A liquid crystal display device according to the present invention comprises: a first substrate having a first electrode and a first alignment film; a second substrate having a second electrode and a second alignment film; a liquid crystal layer interposed between the first alignment film and the second alignment film; and an alignment sustaining layer provided on the liquid crystal layer side of each of the first alignment film and the second alignment film, wherein, the first electrode includes a conductive portion and a non-conductive portion whose perimeter is partly surrounded by the conductive portion; the first substrate further includes an insulating layer at least partly covered by the first electrode; and the insulating layer includes a first region provided at a position overlapping the conductive portion and a second region provided at a position corresponding to the non-conductive portion, the second region being made of a material having a higher specific resistance than that of the first region.

### Advantageous Effects of Invention

In a liquid crystal display device according to the present invention, deteriorations in display quality are reduced.

### BRIEF DESCRIPTION OF DRAWINGS

FIG. 1 (a) is a schematic diagram showing a first embodiment of the liquid crystal display device according to the present invention, and (b) is a schematic plan view of the liquid crystal display device.

FIG. 2 A diagram showing an SEM image of an alignment sustaining layer of the liquid crystal display device of the first embodiment.

FIGS. 3 (a) and (b) are schematic diagrams for describing a method of producing the liquid crystal display device of the first embodiment.

FIG. 4 (a) to (e) are schematic diagrams for specifically describing a method of producing the liquid crystal display device of the first embodiment.

FIG. 5 A schematic diagram showing a second embodiment of the liquid crystal display device according to the present invention.

FIG. 6 (a) is a schematic diagram showing a third embodiment of the liquid crystal display device according to the present invention, and (b) is a schematic plan view of the liquid crystal display device.

FIG. 7 A schematic diagram showing a fourth embodiment of the liquid crystal display device according to the present invention.

FIG. 8 (a) is a schematic diagram showing a fifth embodiment of the liquid crystal display device according to the present invention, and (b) is a schematic plan view of the liquid crystal display device.

### DESCRIPTION OF EMBODIMENTS

Hereinafter, with reference to the drawings, embodiments of the liquid crystal display device according to the present invention will be described. However, the present invention is not limited to the following embodiments.

### Embodiment 1

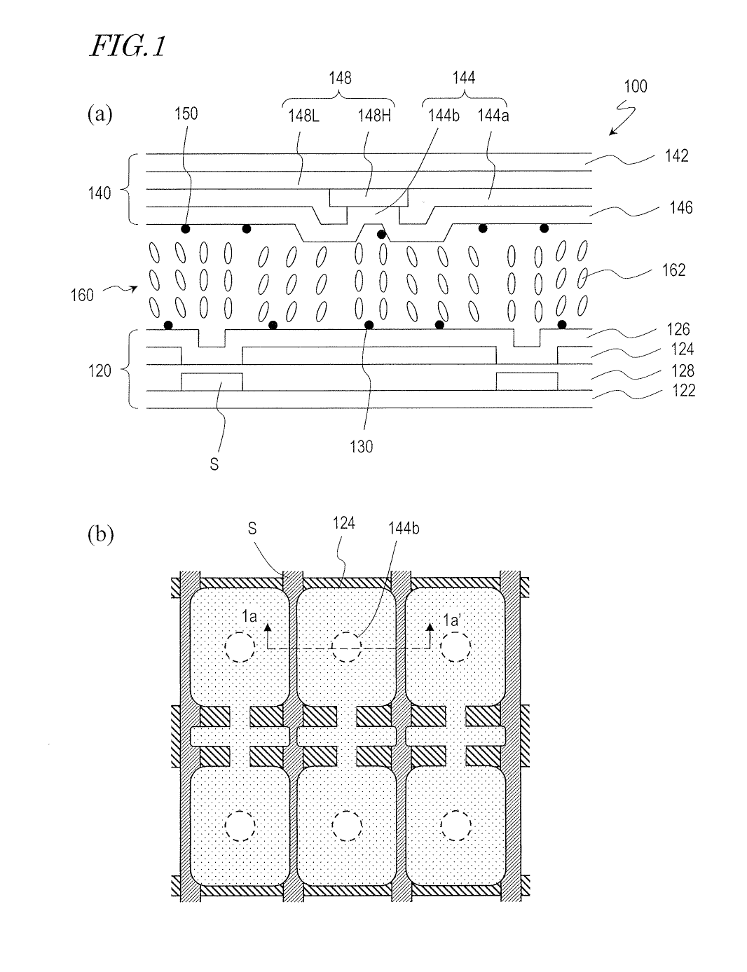

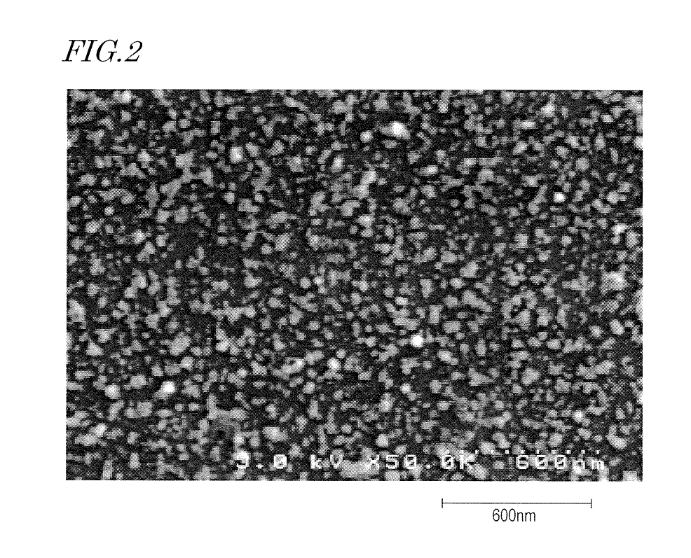

Hereinafter, with reference to FIG. 1 and FIG. 2, a first embodiment of the liquid crystal display device according to the present invention will be described. FIG. 1(a) shows a schematic diagram of a liquid crystal display device 100 of the present embodiment, and FIG. 1(b) shows a schematic plan view of the liquid crystal display device 100. FIG. 1(b) illustrates pixel electrodes 124, non-conductive portions 144b of a counter electrode 144, and source lines S. FIG. 1(a) corresponds to a cross section along line 1a-1a′ in FIG. 1(b).

The liquid crystal display device 100 includes a rear substrate 120, a front substrate 140, and a liquid crystal layer 160. The rear substrate 120 includes an insulative substrate 122, the pixel electrodes 124, and an alignment film 126. The front substrate 140 includes an insulative substrate 142, a counter electrode 144, and an alignment film 146. The liquid crystal layer 160 is interposed between the rear substrate 120 and the front substrate 140. Herein, the liquid crystal display device 100 is a transmission type. The insulative substrates 122 and 142 are both transparent, and may be glass substrates, for example. The liquid crystal display device 100 includes a backlight not shown.

The liquid crystal display device 100 includes pixels composing a matrix of a plurality of rows and a plurality of columns. On the rear substrate 120, at least one switching element (e.g., a thin film transistor (Thin Film Transistor: TFT)) (not shown here) is provided for each pixel. In the present specification, a “pixel” refers to the smallest unit that expresses a specific gray scale level in displaying; in the case of multicolor displaying, a “pixel” corresponds to a unit that expresses a gray scale level of each of R, G, and B, for example, and is also referred to as a dot. A combination of a red pixel, a green pixel, and a blue pixel composes a single color displaying pixel. A “pixel region” refers to a region of the liquid crystal display device 100 that corresponds to a “pixel” in displaying. The rear substrate is also referred to as an active matrix substrate, whereas the front substrate is also referred to as a counter substrate. In the case where the liquid crystal display device is a color liquid crystal display device, color filters are often provided on the front substrate, this front substrate also being referred to as a color filter substrate.

Source regions of the aforementioned TFTs are electrically connected to the source lines S provided on the insulative substrate 122. The source lines S are covered by an insulating layer 128, with the pixel electrodes 124 being provided upon the insulating layer 128. Although not shown, a polarizer and a phase plate are provided on each of the rear substrate 120 and the front substrate 140, the two polarizers being placed so as to oppose each other with the liquid crystal layer 160 interposed therebetween. The two polarizers are disposed so that their transmission axes (polarization axes) are orthogonal to each other, one along the horizontal direction (row direction) and the other along the vertical direction (column direction).

The liquid crystal layer 160 includes a nematic liquid crystal compound having negative dielectric anisotropy (liquid crystal molecules 162). The liquid crystal layer 160 is a vertical-alignment type such that the liquid crystal molecules 162 are aligned essentially at 90° with respect to the surfaces of the alignment film 126 and the alignment film 146 in the absence of an applied voltage. As necessary, a chiral agent may be added to the liquid crystal layer 160. In cooperation with the polarizers placed in crossed Nicols, the liquid crystal layer 160 performs displaying in the normally black mode.

As shown in FIG. 1(b), each pixel electrode 124 includes a plurality of unit portions, each unit portion having a highly symmetrical shape. When no voltage is applied across the liquid crystal layer 160 or the applied voltage is relatively low, the liquid crystal molecules 162 are aligned essentially perpendicular to the principal faces of the alignment films 126 and 146. On the other hand, when a voltage is applied across the liquid crystal layer 160, the liquid crystal molecules 162 in the liquid crystal layer 160 are aligned with an axisymmetric (C∞) inclination in each unit portion of the pixel electrode 124, whereby liquid crystal domains are formed. As such, the liquid crystal display device 100 may also be said to be of the CPA mode.

In the liquid crystal display device 100 of the present embodiment, an alignment sustaining layer 130 is provided on the liquid crystal layer 160 side of the alignment film 126. The alignment sustaining layer 130 contains a polymerization product which results through polymerization of a photopolymerizable compound. Also, an alignment sustaining layer 150 is provided on the liquid crystal layer 160 side of the alignment film 146. The alignment sustaining layer 150 contains a polymerization product which results through polymerization of a photopolymerizable compound. For example, the alignment sustaining layer 130 may be composed of the same material as the alignment sustaining layer 150. By the alignment sustaining layers 130 and 150, the liquid crystal molecules 162 are sustained in directions which are slightly inclined from the normal directions of the principal faces of the alignment films 126 and 146. Thus, the alignment directions of the liquid crystal molecules 162 are defined by the alignment films 126 and 146 and the alignment sustaining layers 130 and 150. The alignment sustaining layers 130 and 150 may be provided in island shapes on the alignment films 126 and 146, such that portions of the surfaces of the alignment films 126 and 146 are in contact with the liquid crystal layer 160. When the liquid crystal molecules 162 having been aligned with an inclination in accordance with an electric field which is created in the liquid crystal layer 160 are stabilized by the polymerization product, the inclined alignment is sustained even in the absence of an electric field. In the case where the alignment sustaining layers 130 and 150 are formed on the alignment films 126 and 146, the alignment sustaining layers 130 and 150 define the pretilt directions of the liquid crystal molecules 162.

With reference to FIG. 2, an example of the aforementioned alignment sustaining layers 130 and 150 will be described. An SEM image shown in FIG. 2 is obtained by disassembling the liquid crystal display device 100, thereafter removing the liquid crystal material, and then observing with an SEM the surface having been cleaned with a solvent. As can be seen from FIG. 2, each alignment sustaining layer contains particles of a polymerization product with a particle size or 50 nm or less. This polymerization product may grow to a particle size of 1 to 5 μm.

The photopolymerizable compound(s) dissolve into the liquid crystal compound, such that a mixture of the photopolymerizable compound(s) and the liquid crystal compound is used as a liquid crystal material. In the case where the liquid crystal material is surrounded by the rear substrate 120, the front substrate 140, and a sealant, the alignment sustaining layers 130 and 150 are formed through polymerization of the photopolymerizable compound(s) within the liquid crystal material, and the liquid crystal layer 160 is formed from the mixture. Note that the liquid crystal layer 160 may contain some unpolymerized photopolymerizable compound.

Herein, as the photopolymerizable compound, a monomer being capable of polymerization and having one or more ring structures or condensed ring structures and two functional groups directly bound to the aforementioned ring structure(s) or condensed ring structure(s) is used. For example, the photopolymerizable monomer is selected from among those which are represented by general formula (1) below.

P¹-A¹-(Z¹-A²)ₙ-P² (1)

In general formula (1), P¹ and P² are functional groups which each independently of the other are an acrylate, methacrylate, vinyl, vinyloxy, or epoxy group; A¹ and A² are ring structures which each independently of the other represent a 1,4-phenylene or naphthalene-2,6-diyl group; Z¹ is a —COO— or —OCO— group or a single bond; and n is 0, 1, or 2.

In general formula (1) P¹ and P² are preferably acrylate groups; Z¹ is preferably a single bond; and n is preferably 0 or 1. Preferable monomers are compounds represented by the following formula, for example.

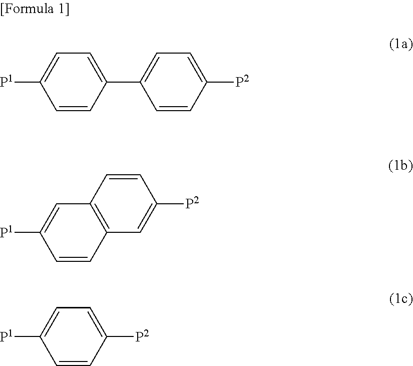

In structural formulae (1a) to (1c), P¹ and P² are as described with respect to general formula (1), where particularly preferable and P² are acrylate groups. Among the aforementioned compounds, those which are very preferable are compounds represented by structural formula (1a) and structural formula (1b), where the compound of structural formula (1a) is particularly preferable.

In the liquid crystal display device 100 of the present embodiment, the front substrate 140 further includes an insulating layer 148 interposed between the insulative substrate 142 and the counter electrode 144. In the liquid crystal display device 100, the insulating layer 148 includes regions 148L which are made of a material with a relatively low specific resistance and regions 148H which are made of a material with a relatively high specific resistance. The specific resistance of the regions 148L is less than 10¹⁵ Ωcm, whereas the specific resistance of the regions 148H is 10¹⁵ Ωcm or more. Herein, the specific resistances of the regions 148L and the regions 148H refer to their bulk resistances. For example, the regions 148L and the regions 148H are made of different resin layers, such that the regions 148L have a specific resistance of 10¹³ Ωcm, and the regions 148H have a specific resistance of 10¹⁵ Ωcm. The thickness of the regions 148L is e.g. 1.5 μm, whereas the thickness of the regions 148H is e.g. 10 μm. For example, the light transmittance through the regions 148H is lower than the light transmittance through the regions 148L. Note that, for functioning as a color filter layer, the insulating layer 148 may be in different colors from pixel to pixel, e.g., red, green, and blue. Alternatively, the insulating layer 148 may be made of a transparent resist resin having a high transmittance (e.g., an acrylic resin) in the visible light region. In the liquid crystal display device 100, the regions 148L and the regions 148H are formed in layers, and are also referred to as an insulating layer 148L and an insulating layer 148H, respectively. Formation of the insulating layer 148 is achieved by, after depositing the insulating layer 148L, forming the insulating layer 148H so as to cover predetermined regions of the insulating layer 148L. Alternatively, the insulating layer 148H may be formed in regions where the material with a low specific resistance has been removed through patterning of the insulating layer 148L.

The counter electrode 144 includes a conductive portion 144a and non-conductive portions 144b surrounded by the conductive portion 144a. The counter electrode 144 is provided in common for the plurality of pixel electrodes 124. The thickness of the conductive portion 144a is 1000 Å. In the liquid crystal display device 100, the non-conductive portions 144b are circular-shaped, and the non-conductive portions 144b are also referred to as apertures. The regions 148H of the insulating layer 148 are provided corresponding to the non-conductive portions 144b of the counter electrode 144, and the regions 148H are at least larger in size than the non-conductive portions 144b.

Although FIG. 1(a) illustrates the regions 148H as being partly covered by the counter electrode 144, the regions 148H may be provided in the non-conductive portions 144b, without being covered by the counter electrode 144. The non-conductive portions 144b of the counter electrode 144 can be formed by patterning an electrically conductive layer. Therefore, unlike formation of rivets, a mask for patterning the electrically conductive layer may be used for the formation of the non-conductive portions 144b.

In the liquid crystal display device 100, when a voltage is applied between a pixel electrode 124 and the counter electrode 144, an oblique electric field occurs between an edge of the pixel electrode 124 and the counter electrode 144, whereby the liquid crystal molecules 162 are aligned in an axisymmetric manner while being inclined around each unit portion of the pixel electrode 124, thus creating axisymmetric liquid crystal domains.

In the liquid crystal display device 100 of the present embodiment, the regions 148H of the insulating layer 148 are provided in the non-conductive portions 144b of the counter electrode 144. If the regions 148H were not provided, however, the relatively low of the specific resistance of the regions 148L would cause the equipotential lines corresponding to the non-conductive portions 144b of the counter electrode 144 to be only gently inclined with respect to the equipotential lines corresponding to the conductive portion 144a even with a voltage being applied across the liquid crystal layer 160. In this case, the alignment centers of axisymmetric inclined alignment would not be stably formed, and the axes of alignment would become unstable, thus resulting in alignment defects. With such alignment defects, if the photopolymerizable monomer were polymerized to form the alignment sustaining layers 130 and 150, the liquid crystal molecules 162 would be sustained in a non-uniform alignment state with respect to the centers of the unit portions of the pixel electrode 124, so that symmetry of axially inclined alignment would be lost and the display quality would be deteriorated. In this case, although the alignment could be stabilized by increasing the non-conductive portions 144b in size, increasing the size of the non-conductive portions 144b would result in a lower aperture ratio. For example, if the specific resistance of the green color filter is lower than the specific resistances of the red and blue color filters, the alignment defects of the green pixel would become more outstanding than those of the red pixel and the blue pixel. Thus, the balance in transmittance might be lost, resulting in a coarse appearance.

The liquid crystal display device 100 of the present embodiment includes the regions 148H having a specific resistance of 10¹⁵ Ωcm or more; thus, the regions 148H corresponding to the non-conductive portions 144b have a relatively high specific resistance. Therefore, when a voltage is applied across the liquid crystal layer 160, the equipotential lines corresponding to the non-conductive portions 144b will be significantly inclined with respect to the equipotential lines corresponding to the conductive portion 144a. Even when a voltage is applied across the liquid crystal layer 160, the liquid crystal molecules 162 will take an axisymmetric inclined alignment around each non-conductive portion 144b, so that fluctuations in the central axis of alignment of the liquid crystal molecules 162 are reduced. When the alignment sustaining layers 130 and 150 are formed by polymerizing the photopolymerizable monomer in this state, the liquid crystal molecules 162 will be maintained in a uniform alignment state with respect to the centers of the unit portions of the pixel electrode 124. In this case, even if the non-conductive portions 144b are small in size, the alignment centers of axisymmetric inclined alignment will be stably formed, and fluctuations in the axes of alignment will be reduced, whereby alignment defects in the liquid crystal display device 100 are suppressed. Even in the case where the transmittance of the regions 148H is lower than the transmittance of the regions 148L, the regions 148H correspond to the non-conductive portions 144b, and the liquid crystal molecules 162 corresponding to the regions 148H are hardly inclined, so that alignment defects can be suppressed without lowering transmittance.

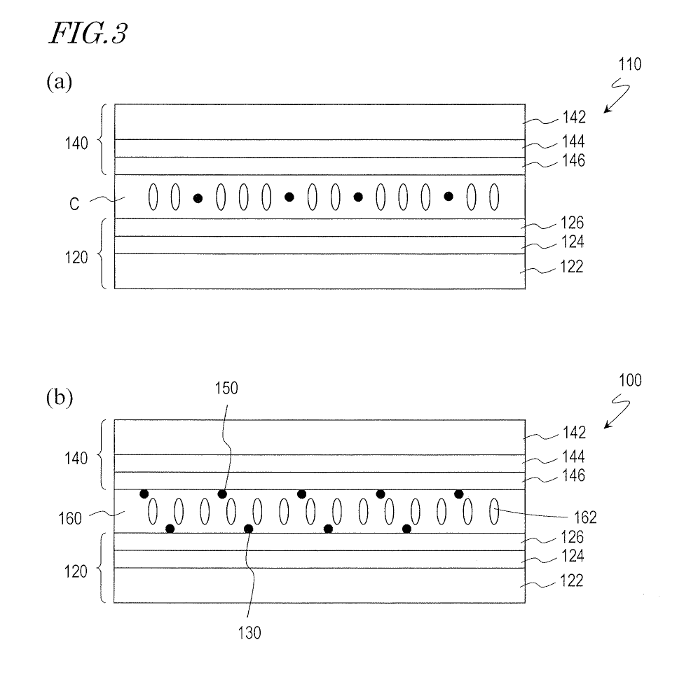

Hereinafter, with reference to FIG. 3, a method of producing the liquid crystal display device 100 will be described.

First, as shown in FIG. 3(a), the liquid crystal cell 110 is provided. The liquid crystal cell 110 includes the rear substrate 120, the front substrate 140, and a mixture C which is interposed between the alignment film 126 of the rear substrate 120 and the alignment film 146 of the front substrate 140. The mixture C is made of a liquid crystal material in which a liquid crystal compound and a photopolymerizable compound are mixed. Herein, the aforementioned photopolymerizable monomer is used as the photopolymerizable compound. The photopolymerizable monomer has a concentration of 0.30 wt % on the basis of the liquid crystal material. The mixture C is sealed with a sealant (not shown in FIG. 3). The sealant may be a photocurable resin (e.g., an acrylic resin) or a thermosetting resin (e.g., an epoxy resin). Alternatively, it may have both photocurable and thermosetting functions.

For example, the liquid crystal cell 110 is produced as follows. A sealant is introduced in the shape of a rectangular frame onto one of the rear substrate 120 and the front substrate 140, and the liquid crystal material is added dropwise within the region surrounded by the sealant. Thereafter, the rear substrate 120 and the front substrate 140 are attached together, and the sealant is cured. Such dropwise addition of a liquid crystal material is also called a One Drop Filling (ODF). ODF achieves introduction of the liquid crystal material in a uniform manner and in a short time, and allows a batch processing from a mother glass substrate. Furthermore, the amount of discarded liquid crystal material can be reduced, thus enabling efficient use of the liquid crystal material.

Alternatively, for example, a sealant made of a thermosetting resin is introduced onto one of the rear substrate 120 and the front substrate 140 in the shape of a partially opened rectangular frame, and thereafter the rear substrate 120 and the front substrate 140 are attached together, and the sealant is cured via a heat treatment to form an empty cell. Thereafter, the liquid crystal material is injected in between the rear substrate 120 and the front substrate 140, and furthermore a photocurable sealant may be cured in order to seal the aperture, for example.

Next, under an applied voltage, the liquid crystal cell 110 is irradiated with ultraviolet light in order to polymerize the photopolymerizable monomer within the liquid crystal material, and as shown in FIG. 3(b), the alignment sustaining layer 130 is formed on the liquid crystal layer 160 side of the alignment film 126 of the rear substrate 120, and the alignment sustaining layer 150 is formed on the liquid crystal layer 160 side of the alignment film 146 of the front substrate 140. When a voltage is applied between the pixel electrodes 124 and the counter electrode 144, the liquid crystal molecules 162 will be aligned in accordance with electric fields which are formed between the pixel electrodes 124 and the counter electrode 144. By forming a polymer in this state, the liquid crystal molecules 162 near the alignment films 126 and 146 will receive strong regulation in this state; even when the voltage is thereafter removed, the liquid crystal molecules 162 will remain inclined with respect to the normal directions of the principal faces of the alignment films 126 and 146. The above treatment is generally performed at room temperature (e.g., 20° C.).

In the case where a large amount of photopolymerizable monomer is left within the liquid crystal layer 160 after ultraviolet light irradiation is performed with a voltage being applied between the pixel electrode 124 and the counter electrode 144, ultraviolet light may be radiated without applying a voltage between the pixel electrode 124 and the counter electrode 144, thus reducing the concentration of remaining photopolymerizable monomer. Thereafter, driving circuits and polarizers are mounted as necessary. In this manner, the liquid crystal display device 100 is produced.

As mentioned earlier, the liquid crystal cell 110 may be produced through ODF. In this case, production of the liquid crystal display device 100 takes place as follows.

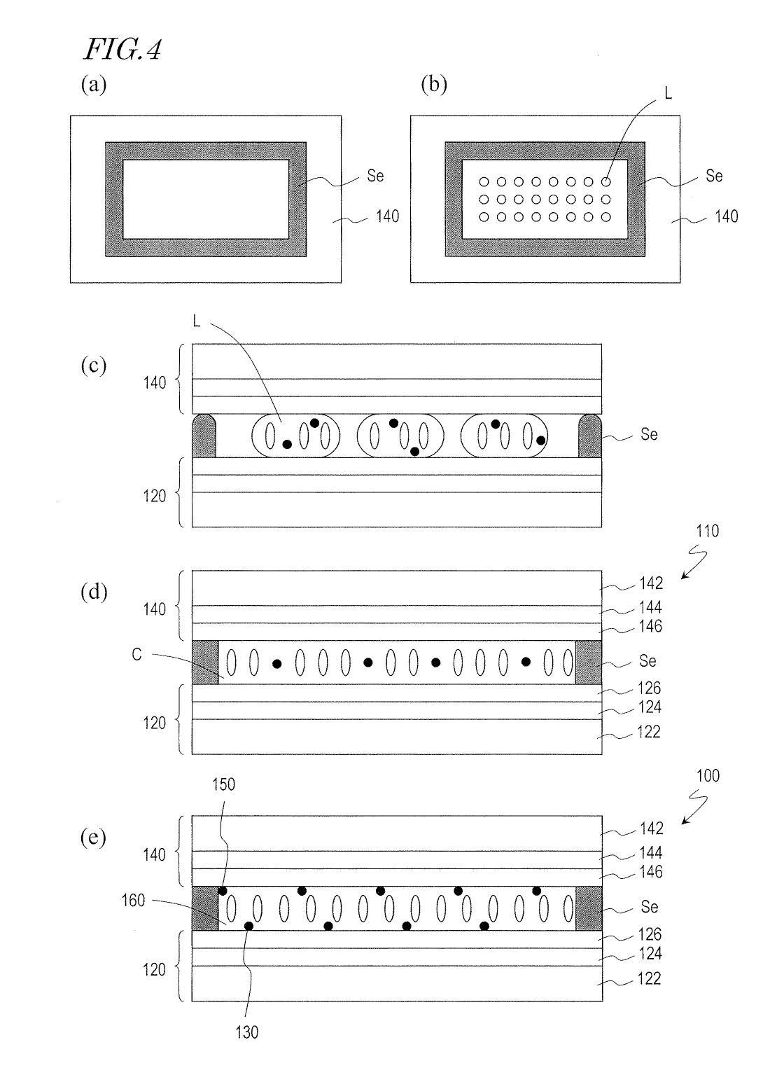

First, as shown in FIG. 4(a), a sealant Se defining the displaying region is introduced onto the front substrate 140, for example. The sealant Se is made of a photocurable or a thermosetting resin, for example; specifically, it is made of an acrylic resin or an epoxy resin. Alternatively, the sealant Se is made of a resin having both photocurable and thermosetting characteristics.

Next, as shown in FIG. 4(b), a liquid crystal material L is added dropwise in the displaying region. The liquid crystal material L has a liquid crystal compound and a photopolymerizable monomer mixed therein.

Next, as shown in FIG. 4(c), the rear substrate 120 is attached onto the front substrate 140. The attachment is conducted in a vacuum ambient. After the attachment, it is left open to the atmospheric pressure. Thereafter, the sealant Se is irradiated with light to cure the sealant Se. Moreover, the liquid crystal cell 110 is subjected to further heat treatment to cure the sealant Se. Thereafter, a cut treatment is performed as necessary in order to obtain terminals for PSA.

Next, as shown in FIG. 4(d), a voltage is applied between the pixel electrodes 124 and the counter electrode 144, and the liquid crystal cell 110 is irradiated with light. The voltage application is conducted as follows. For example, while continuously applying a gate voltage of 10 V to the gate lines of the liquid crystal cell 110 in order to maintain the TFT provided for each pixel in an ON state, a data voltage of 5 V is applied to all of the source lines, and rectangular waves with an amplitude of 10 V (maximum 10 V and minimum 0 V) are applied to the counter electrode. As a result, an AC voltage of ±5 V is applied between the pixel electrodes 124 and the counter electrode 144. Thus, a higher voltage than that for displaying the highest gray scale level in the usual displaying by the liquid crystal display device is applied between the pixel electrodes 124 and the counter electrode 144. When applying a voltage to the rear substrate 120, the voltage to be applied to the gate lines may be made higher than the source line voltage (i.e., the voltage on the pixel electrodes 124), whereby disorder in the liquid crystal alignment is reduced and a display quality with little coarseness can be obtained. Conversely, if the gate voltage is made lower than the source voltage, the pixels may become floating (unstable voltage), in which case the liquid crystal alignment is also likely to become unstable, thus inducing coarseness.

With such voltage application, ultraviolet light (e.g., i-line with a wavelength of 365 nm, about 5.8 mW/cm²) is radiated for about 3 to 5 minutes. With this irradiation, the photopolymerizable monomer within the liquid crystal material is polymerized to form a polymer, whereby the alignment sustaining layers 130 and 150 are formed as shown in FIG. 4(e). With this irradiation, a pretilt of 0.1° to 5° is conferred. Note that, in the case where a color filter layer is formed on the front substrate 140, the intensity of the wavelength reaching the liquid crystal layer will differ depending on the pixel color, and therefore light irradiation is conducted through the rear substrate 120.

Next, under no applied voltage, ultraviolet light of about 1.4 mW/cm² is radiated for about 1 to 2 hours by using black light, for example. As a result, the photopolymerizable monomer remaining in the liquid crystal layer after the earlier irradiation is further polymerized, whereby the polymerizable monomer concentration is reduced.

This irradiation is also conducted through the rear substrate 120. Via this irradiation, the photopolymerizable monomer remaining in the liquid crystal material is adsorbed or chemically bonded onto the alignment sustaining layers 130 and 150, and also polymerization occurs between photopolymerizable monomers; this makes it possible to reduce the photopolymerizable monomer remaining in the liquid crystal material. If there were a lot of remaining photopolymerizable monomers, photopolymerizable monomers remaining in the liquid crystal layer in small amounts would polymerize at a further slower pace during the operation of the liquid crystal display device, thus inducing image sticking. However, conducting irradiation in the above manner can prevent image sticking. As compared to the aforementioned ultraviolet light which is radiated under an applied voltage, the ultraviolet light to be radiated under no applied voltage has a low illuminance and receives a generally long radiation time. The above series of steps may also be referred to as a “PSA treatment”. Thereafter, polarizers and driving circuits are mounted as necessary.

Although the liquid crystal material is added dropwise onto the front substrate 140 in the above description, the present invention is not limited thereto. The liquid crystal material may be added dropwise onto the rear substrate 120. In the case where sealant curing is performed by irradiating the sealant with light, it is preferable that the light be radiated through the rear substrate 120 because, generally speaking, a black matrix is provided in the frame region of the front substrate. When the liquid crystal material is added dropwise onto the front substrate 140, without turning over the liquid crystal cell 110 having been formed by attaching the rear substrate 120 onto the front substrate 140, the liquid crystal cell 110 may be moved to a substrate stage where a light source is provided above, and irradiated with light from the upper light source, thus achieving irradiation through the rear substrate 120. Thus, by adding dropwise the liquid crystal material onto the front substrate 140, the liquid crystal display device can be easily produced.

The voltage during the ultraviolet light irradiation may be applied in the following manner. While continuously applying a gate voltage of 15 V to all of the gate lines in the displaying region of the liquid crystal cell 110 in order to maintain the TFT provided for each pixel in an ON state, a data voltage of 0 V is applied to all of the source lines, and rectangular waves with an amplitude of 10 V (maximum 5 V and minimum −5 V) are applied to the counter electrode. As a result of this, an AC voltage of ±5 V is applied across the liquid crystal layer.

Depending on the value of voltage applied across the liquid crystal layer and the ultraviolet irradiation time, it is possible to control the alignment regulating force and the pretilt angle. Stepwise increases in the voltage of the counter electrode may reduce disorder in the alignment state within the pixel, thus providing a display quality free of coarseness.

As the light source, a low-pressure mercury lamp (a sterilization lamp, a fluorescent chemical lamp, a black light), a high-pressure discharge lamp (a high-pressure mercury lamp, a metal halide lamp), or a short arc discharge lamp (an ultrahigh-pressure mercury lamp, a xenon lamp, a mercury xenon lamp), or the like may be used. Light from the light source may be straightforwardly used for irradiation, or a specific wavelength (or a specific wavelength region) that is selected through a filter may be used for irradiation.

### Embodiment 2

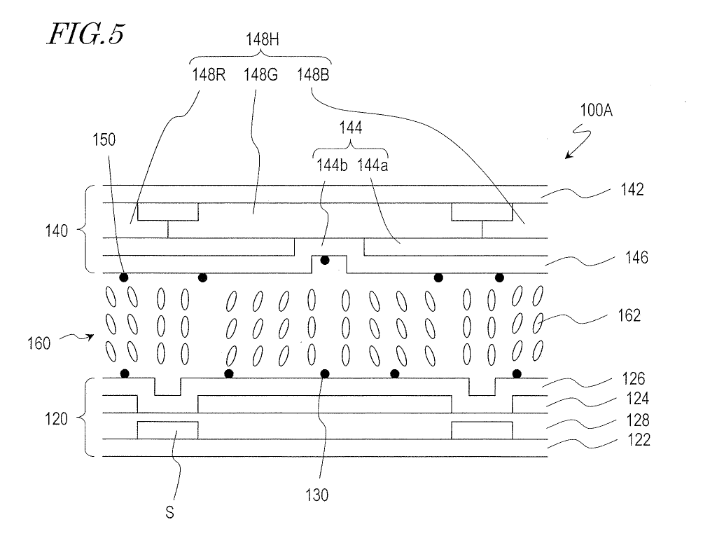

Hereinafter, with reference to FIG. 5, a second embodiment of the liquid crystal display device according to the present invention will be described. Except that the insulating layer 148H is in red, green, and blue, a liquid crystal display device 100A of the present embodiment has a similar construction to that of the liquid crystal display device of Embodiment 1 described above, and any overlapping descriptions will be omitted to avoid redundancy.

In the liquid crystal display device 100A, the insulating layer 148H has a region 148R appearing in red, a region 148G appearing in green, and a region 148B appearing in blue. The regions 148R, 148G, and 148B of the insulating layer 148H are each made of a pigment-dispersed type resist material, the pigment-dispersed type resist material containing for example a pigment, as well as a binder, a photocurable resist (e.g., an acrylic resin), a photopolymerization initiator, and the like. The specific resistance of each of the regions 148R, 148G, and 148B is 10¹⁵ Ωcm or more. The insulating layer 148H functions as a color filter layer.

In the liquid crystal display device 100A, the insulating layer 148H corresponding to the non-conductive portions 144b has a relatively high specific resistance. Therefore, when a voltage is applied across the liquid crystal layer 160, the equipotential lines corresponding to the non-conductive portions 144b will be significantly inclined with respect to the equipotential lines corresponding to the conductive portion 144a, and the alignment centers of axisymmetric inclined alignment will be stably formed, and fluctuations in the axes of alignment will be reduced. In this manner, alignment defects are suppressed in the liquid crystal display device 100A.

Although herein the specific resistance of the color filter layer 148H is 10¹⁵ Ωcm or more, the present invention is not limited thereto. A resin layer having a specific resistance of 10¹⁵ Ωcm or more may be provided between the insulative substrate 142 and the counter electrode 144. This resin layer may have been planarized, and the resin layer can suppress decreases in contrast at the alignment disorder even if the color filter layers 148R, 148G, and 148B are partly overlapping at the pixel boundary. Resin spacers for retaining cell thickness may be provided on the resin layer, or in the case where the liquid crystal display device 100A is of a transmission/reflection dual-use type, a transparent dielectric layer may be provided over the resin layer in the reflective region.

### Embodiment 3

In the above description, the front substrate has an insulating layer including regions of a relatively high specific resistance; however, the present invention is not limited thereto. The rear substrate may have an insulating layer including regions of a relatively high specific resistance.

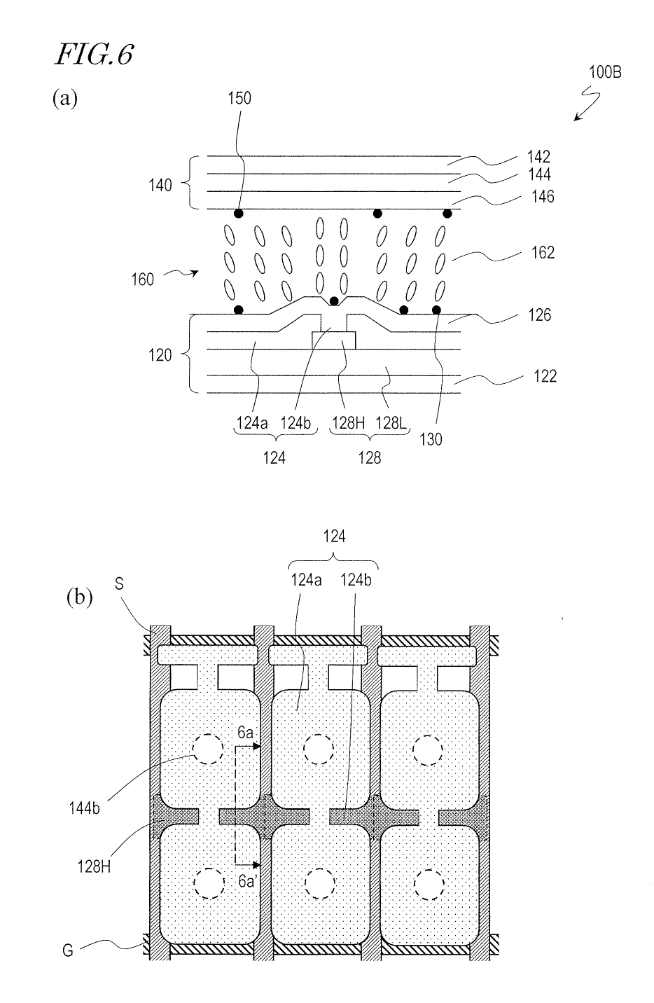

Hereinafter, with reference to FIG. 6, a third embodiment of the liquid crystal display device according to the present invention will be described. FIG. 6(a) shows a schematic diagram of a liquid crystal display device 100B of the present embodiment, and FIG. 6(b) shows a schematic plan view of the liquid crystal display device 100B. FIG. 6(b) shows conductive portions 124a and non-conductive portions 124b of pixel electrodes 124.

Except that the insulating layer 128 of the rear substrate 120s (and not the insulating layer 148 of the front substrate 140) includes regions 128L and regions 128H, the liquid crystal display device 100B of the present embodiment has a similar construction to that of the liquid crystal display device of Embodiment 1 described above, and any overlapping descriptions will be omitted to avoid redundancy.

The counter electrode 144 includes a conductive portion 144a and non-conductive portions 144b surrounded by the conductive portion 144a. The counter electrode 144 is provided in common for the plurality of pixel electrodes 124.

In the liquid crystal display device 100B, the insulating layer 128 includes the regions 128L made of a material with a relatively low specific resistance and the regions 128H made of a material with a relatively high specific resistance. The specific resistance of the regions 128L is less than 10¹⁵ Ωcm, whereas the specific resistance of the regions 128H is 10¹⁵ Ωcm or more. For example, the specific resistance of the regions 128L is 10¹³ Ωcm, and the specific resistance of the regions 128H is 10¹⁵ Ωcm. The insulating layer 128 is in different colors from pixel to pixel, e.g., red, green, and blue.

Each pixel electrode 124 includes a conductive portion 124a and non-conductive portions 124b whose perimeter is partly surrounded by the conductive portion 124a. The conductive portion 124a includes a plurality of unit portions which are electrically connected to one another. The non-conductive portions 124b are provided between adjoining unit portions, such that the perimeter of each non-conductive portion 124b is partly surrounded by the conductive portion 124a. The non-conductive portions 124b of the pixel electrode 124 can be formed by patterning an electrically conductive layer.

The regions 128H of the insulating layer 128 are provided corresponding to the non-conductive portions 124b. In FIG. 6(a), each region 128H is partly covered by the conductive portion 124a; however, the regions 128H may be provided in the non-conductive portions 124b, without being covered by the conductive portion 124a.

When a predetermined voltage is applied across the liquid crystal layer 160, the liquid crystal molecules 162 are aligned in an axisymmetric manner while being inclined around each unit portion of the pixel electrode 124, thus creating axisymmetric liquid crystal domains. In the liquid crystal display device 100B of the present embodiment, since the regions 128H are provided corresponding to the non-conductive portions 124b of the pixel electrode 124, even when a voltage is applied between the pixel electrode 124 and the counter electrode 144, the equipotential lines corresponding to the non-conductive portions 124b will be significantly inclined with respect to the equipotential lines corresponding to the conductive portion 124a. Therefore, boundaries between different liquid crystal domains are stably formed, and alignment defects are suppressed in the liquid crystal display device 100B. Moreover, in the liquid crystal display device 100B, since the insulating layer 128H having a high specific resistance is provided between adjoining unit portions, a relatively intense oblique electric field is applied to the liquid crystal molecules 162 near the unit portion edges, thereby suppressing a substantial decrease in the aperture ratio.

Note that, even if the transmittance of the regions 128H is lower than the transmittance of the regions 128L, the liquid crystal molecules 162 corresponding to the regions 128H are aligned essentially perpendicular to the normal direction of the principal faces of the alignment films 126 and 146, whereby decreases in transmittance are reduced. In the above description, the regions 128H are provided corresponding to the non-conductive portions 124b; however, the regions 128H may be provided between adjoining pixel electrodes 124.

### Embodiment 4

Although the insulating layer 128 of the rear substrate 120 in the liquid crystal display device 100B includes regions that are made of materials with different specific resistances, the present invention is not limited thereto.

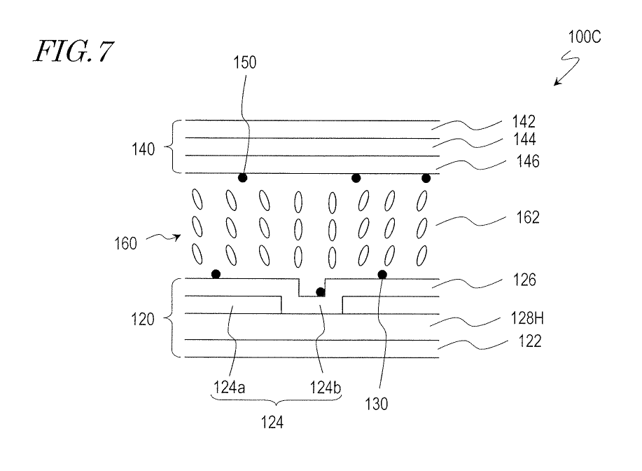

Hereinafter, with reference to FIG. 7, a fourth embodiment of the liquid crystal display device according to the present invention will be described. Except that the insulating layer 128H of the rear substrate 120 is made of a material with a relatively high specific resistance, without including any region that is made of a material with a relatively low specific resistance, a liquid crystal display device 100C of the present embodiment has a similar construction to that of the liquid crystal display device 100B described above, and any overlapping descriptions will be omitted to avoid redundancy.

In the liquid crystal display device 100C, the insulating layer 128H has a specific resistance of 10¹⁵ Ωcm. The insulating layer 128H is made of an acrylic resin. The insulating layer 128H may have been planarized, or may function as a so-called interlayer film. The insulating layer 128H has a specific resistance of 10¹⁵ Ωcm or more. Since the specific resistance of the insulating layer 128H corresponding to a non-conductive portion 124b is relatively high, when a voltage is applied across the liquid crystal layer 160, the equipotential lines corresponding to the non-conductive portion 124b will be significantly inclined with respect to the equipotential lines corresponding to a conductive portion 124a, whereby boundaries between liquid crystal domains are stably formed, and alignment defects are suppressed. Moreover, in the liquid crystal display device 100C, the insulating layer 128H having a high specific resistance is provided also between adjoining pixel electrodes 124, a relatively intense oblique electric field is applied to the liquid crystal molecules 162 near the edge of the pixel electrode 124, thereby suppressing a substantial decrease in the aperture ratio.

### Embodiment 5

The liquid crystal display devices in the above descriptions are of the CPA mode; however, the present invention is not limited thereto.

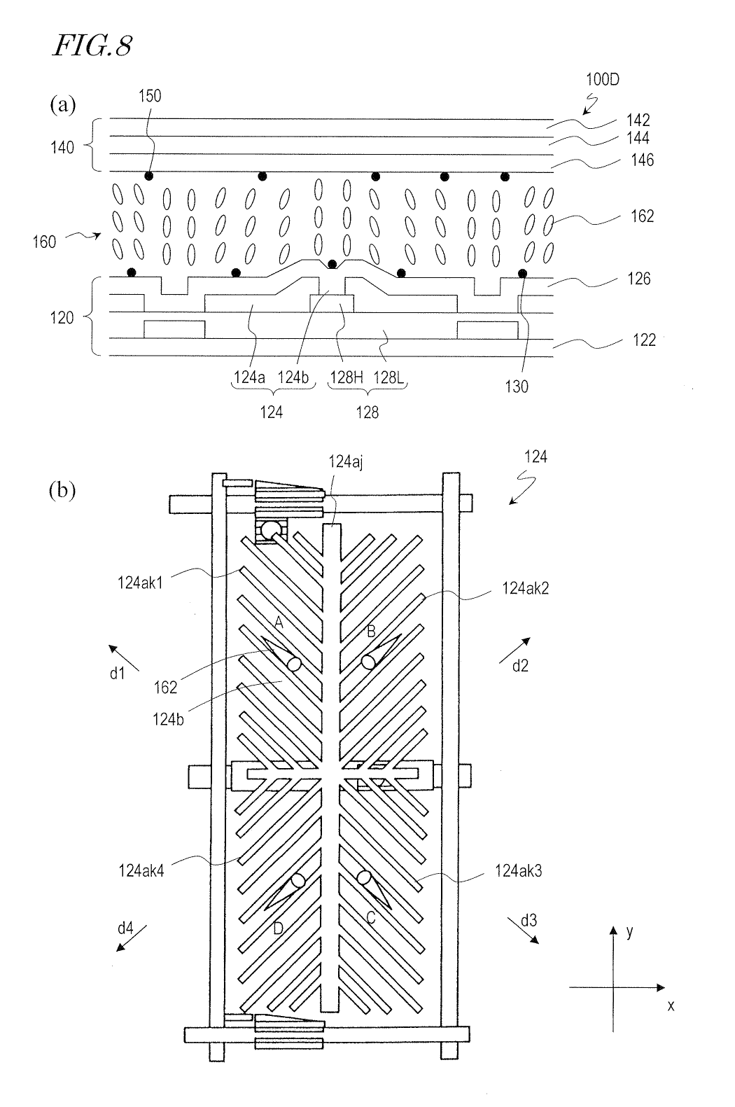

Hereinafter, with reference to FIG. 8, a fifth embodiment of the liquid crystal display device according to the present invention will be described. FIG. 8(a) shows a schematic diagram of a liquid crystal display device 100D of the present embodiment, and FIG. 8(b) shows a schematic plan view of the liquid crystal display device 100D. FIG. 8(b) shows a pixel electrode 124 and liquid crystal molecules 162 in the liquid crystal display device 100D. Except for the different shape of the pixel electrode 124, the liquid crystal display device 100D of the present embodiment has a similar construction to that of the above-described liquid crystal display device, and any overlapping descriptions will be omitted to avoid redundancy.

As shown in FIG. 8(b), in the liquid crystal display device 100D, the pixel electrode 124 includes a conductive portion 124a and non-conductive portions 124b whose perimeter is partly surrounded by the conductive portion 124a. The conductive portion 124a includes a cross-shaped stem 124aj, and branches 124ak1 to 124ak4 extending from the stem 124aj in four different directions d1 to d4. Such a structure of the pixel electrode 124 is also called a fishbone structure. Note that the stem 124aj extends along the x direction and along the y direction. For example, the stem 124aj has a width of 3 μm. Moreover, the branches 124ak1, 124ak2, 124ak3, and 124ak4 have a width of 3 μm, and any interspace therebetween (i.e., the width of any non-conductive portion 124b between branches 124ak1 to 124ak4) is 3 μm. Defining the horizontal direction (right-left direction) on the display screen (plane of the figure) as a reference of the azimuthal direction, and defining the leftwise rotation as positive (i.e., if the display surface were a clock face, the 3 o'clock direction would be an azimuth angle of 0°, and the counterclockwise would be positive), the directions d1 to d4 are 135°, 45°, 315°, and 225°, respectively.

When a voltage is applied across the liquid crystal layer 160 in the liquid crystal display device 100D, the liquid crystal molecules 162 are aligned in parallel to the directions in which the corresponding branches 124ak1 to 124ak4 extend, as shown in FIG. 6(b). The liquid crystal layer 160 is a vertical-alignment type, and the liquid crystal layer 160 has a liquid crystal domain A formed by the branches 124ak1, a liquid crystal domain B formed by the branches 124ak2, a liquid crystal domain C formed by the branches 124ak3, and a liquid crystal domain D formed by the branches 124ak4. When no voltage is applied across the liquid crystal layer 160 or the applied voltage is relatively low, the liquid crystal molecules 162 are aligned perpendicular to the principal faces of alignment films which are not shown, except in the neighborhood of the pixel electrode 124. On the other hand, when a predetermined voltage is applied across the liquid crystal layer 160, the liquid crystal molecules 162 are aligned along the directions d1 to d4 in which the branches 124ak1, 124ak2, 124ak3, and 124ak4 extend.

In the present specification, the alignment direction of liquid crystal molecules at the center of each liquid crystal domain A to D is referred to as a reference alignment direction, and, within the reference alignment direction, an azimuth angle component that is in a direction from the rear face toward the front face along the major axis of the liquid crystal molecules (i.e., an azimuth angle component as projected onto the principal face of an alignment film) is referred to as a reference alignment azimuth. The reference alignment azimuth characterizes its corresponding liquid crystal domain, and predominantly affects the viewing angle characteristics of the liquid crystal domain. When the horizontal direction (right-left direction) on the display screen (plane of the figure) is defined as a reference of the azimuthal direction and the leftwise rotation is defined as positive, the reference alignment azimuth of the four liquid crystal domains A to D are set to be four azimuths such that the difference between any two azimuths is substantially equal an integer multiple of 90°. Specifically, the reference alignment azimuths of the liquid crystal domains A, B, C, and D are, respectively, 315°, 225°, 135° and 45°. Since the liquid crystal molecules 162 are thus aligned in four different azimuths, the viewing angle characteristics are improved.

Thus, in the case where the pixel electrode has a fishbone structure, the alignment of the liquid crystal molecules may be disturbed at the intersections between the stem and the branches to create unintended liquid crystal domains. However, in the liquid crystal display device 100D the present embodiment, a region 128H having a relatively high specific resistance is provided corresponding to any non-conductive portion 124b between adjoining branches 124ak1, and similarly, a region 128H having a relatively high specific resistance is provided corresponding to the non-conductive portion 124b between each of adjoining branches 124ak2 to 124ak4. Therefore, relatively intense oblique electric fields are applied near the edges of the branches 124ak1 to 124ak4, so that the alignment of the liquid crystal molecules 162 becomes stable, and even when the inter-conductive portion 124a distance (i.e., the width of each non-conductive portion 124b) is short, alignment defects can be suppressed, and deteriorations in display quality can be suppressed.

Note that the liquid crystal display device may be of any other VA mode, such as the so-called MVA mode. Alternatively, the liquid crystal display device may be of yet another ECB mode, or the liquid crystal display device may be of the TN mode.

Although the liquid crystal display devices are transmission types in the above descriptions, the present invention is not limited thereto. The liquid crystal display devices may be reflection types, or transmission/reflection dual-use types.

The disclosure of Japanese Patent Application No. 2009-75110, which forms the basis of priority of the present application, is incorporated herein by reference.

### INDUSTRIAL APPLICABILITY

According to the present invention, deteriorations in the display quality of a liquid crystal display device can be suppressed. Such a liquid crystal display device is suitably used not only as a small-sized display device, e.g., the display section of a mobile phone, but also as a large-sized display device, e.g., a television set.

### REFERENCE SIGNS LIST

100 liquid crystal display device
120 rear substrate
122 insulative substrate
124 pixel electrode
124a conductive portion
124b non-conductive portion
126 alignment film
128 insulating layer
130 alignment sustaining layer
140 front substrate
142 insulative substrate
144 counter electrode
144a conductive portion
144b non-conductive portion
146 alignment film
148 insulating layer
150 alignment sustaining layer
160 liquid crystal layer
162 liquid crystal molecules

1. A liquid crystal display device comprising:
a first substrate having a first electrode and a first alignment film;
a second substrate having a second electrode and a second alignment film;
a liquid crystal layer interposed between the first alignment film and the second alignment film; and
an alignment sustaining layer provided on the liquid crystal layer side of each of the first alignment film and the second alignment film, wherein,
the first electrode includes a conductive portion and a non-conductive portion whose perimeter is at least partly surrounded by the conductive portion;
the first substrate further includes an insulating layer at least partly covered by the first electrode; and
at a position corresponding to the non-conductive portion, the insulating layer includes a region which is made of a material having a specific resistance of 10¹⁵ Ωcm or more.

2. The liquid crystal display device of claim 1, wherein, at a position overlapping the conductive portion, the insulating layer further includes a region which is made of a material having a specific resistance of less than 10¹⁵ Ωcm.

3. The liquid crystal display device of claim 2, wherein the insulating layer includes: a first insulating layer including the region which is made of the material having a specific resistance of less than 10¹⁵ Ωcm; and a second insulating layer including the region which is made of the material having a specific resistance of 10¹⁵ Ωcm or more.

4. The liquid crystal display device of claim 3, wherein the second insulating layer is provided on the liquid crystal layer side of the first insulating layer.

5. The liquid crystal display device of claim 1, wherein the first substrate is a front substrate.

6. The liquid crystal display device of claim 5, wherein the insulating layer functions as a color filter layer.

7. The liquid crystal display device of claim 1, wherein the first substrate is a rear substrate.

8. The liquid crystal display device of claim 7, wherein,
the conductive portion of the first electrode includes a plurality of unit portions which are electrically connected to one another; and
the region of the insulating layer that is made of the material having a specific resistance of 10¹⁵ Ωcm or more is provided corresponding to an interspace between two adjoining unit portions among the plurality of unit portions.

9. A liquid crystal display device comprising:
a first substrate having a first electrode and a first alignment film;
a second substrate having a second electrode and a second alignment film;
a liquid crystal layer interposed between the first alignment film and the second alignment film; and
an alignment sustaining layer provided on the liquid crystal layer side of each of the first alignment film and the second alignment film, wherein,
the first electrode includes a conductive portion and a non-conductive portion whose perimeter is partly surrounded by the conductive portion;
the first substrate further includes an insulating layer at least partly covered by the first electrode; and
the insulating layer includes a first region provided at a position overlapping the conductive portion and a second region provided at a position corresponding to the non-conductive portion, the second region being made of a material having a higher specific resistance than that of the first region.
